(19) United States
(12) Patent Application Publication
(10) Pub. No.: US 2005/0114224 A1
(43) Pub. Date: May 26, 2005

(54) Methods for providing communications services

(76) Inventors: Donna K. Hodges, Cumming, GA (US); Barrett Morris Kreiner, Norcross, GA (US); Steven N. Tischer, Atlanta, GA (US)

Correspondence Address: Scott P. Zimmerman, P.O. Box 3822, Cary, NC, 27519, US

(21) Appl. No.: 10/720,780

(22) Filed: Nov. 24, 2003

(51) Int. Cl. G06F 17/60

(52) U.S. Cl. 705/26; 705/37

(57) ABSTRACT

Methods, systems, and products are disclosed for providing communications services. One method receives a bid for the communications services, and the bid is received during an online auction conducted via a distributed computing network. The communications services are provided, and a rating is received. The rating indicates whether the communications services were satisfactorily provided.

### CROSS-REFERENCE TO RELATED APPLICATIONS

This application relates to the copending and the commonly assigned U.S. application Ser. No. XX/XXX,XXX, entitled “Methods for Providing Communications Services” (Attorney Docket BS030006), filed concurrently herewith, and of which the “Brief Summary of the Invention” section and the “Detailed Description of the Invention” section are incorporated herein by reference.

This application relates to the copending and the commonly assigned U.S. application Ser. No. XX/XXX,XXX, entitled “Methods for Providing Communications Services” (Attorney Docket BS030347), filed concurrently herewith, and of which the “Brief Summary of the Invention” section and the “Detailed Description of the Invention” section are incorporated herein by reference.

This application relates to the copending and the commonly assigned U.S. application Ser. No. XX/XXX,XXX, entitled “Methods for Providing Communications Services” (Attorney Docket BS030348), filed concurrently herewith, and of which the “Brief Summary of the Invention” section and the “Detailed Description of the Invention” section are incorporated herein by reference.

This application relates to the copending and the commonly assigned U.S. application Ser. No. XX/XXX,XXX, entitled “Methods for Providing Communications Services” (Attorney Docket BS030359), filed concurrently herewith, and of which the “Brief Summary of the Invention” section and the “Detailed Description of the Invention” section are incorporated herein by reference.

This application relates to the copending and the commonly assigned U.S. application Ser. No. XX/XXX,XXX, entitled “Methods for Providing Communications Services” (Attorney Docket BS030351), filed concurrently herewith, and of which the “Brief Summary of the Invention” section and the “Detailed Description of the Invention” section are incorporated herein by reference.

This application relates to the copending and the commonly assigned U.S. application Ser. No. XX/XXX,XXX, entitled “Methods for Providing Communications Services” (Attorney Docket BS030352), filed concurrently herewith, and of which the “Brief Summary of the Invention” section and the “Detailed Description of the Invention” section are incorporated herein by reference.

This application relates to the copending and the commonly assigned U.S. application Ser. No. XX/XXX,XXX, entitled “Methods for Providing Communications Services” (Attorney Docket BS030353), filed concurrently herewith, and of which the “Brief Summary of the Invention” section and the “Detailed Description of the Invention” section are incorporated herein by reference.

This application relates to the copending and the commonly assigned U.S. application Ser. No. XX/XXX,XXX, entitled “Methods for Providing Communications Services” (Attorney Docket BS030356), filed concurrently herewith, and of which the “Brief Summary of the Invention” section and the “Detailed Description of the Invention” section are incorporated herein by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to computers and to communications and, more particularly, to processing data in a communications network.

2. Description of the Related Art

Manipulation of electronic data is important in computer networking and in communications. Often times electronic data must be manipulated for presentation at a client communications device. That is, the electronic data must be changed, formatted, or altered to suit the display characteristics, processing abilities, and/or storage capabilities of the client communications device. A handheld personal data assistant, for example, often requires that bandwidth-intensive electronic data, such as on-demand video, be scaled, color corrected, and/or otherwise manipulated for optimum presentation on the small display of the handheld personal data assistant. Heretofore, however, manipulation of electronic data was usually the responsibility of the client communications device—that is, the client communications device stores and utilizes one or more computer programs to manipulate incoming electronic data for presentation on the client communications device.

Locally manipulating electronic data, however, poses problems. As the electronic data is received, the client communications device must store the electronic data, process/manipulate the electronic data, and present the manipulated electronic data to the user. This process of storing, manipulating, and/or presenting the electronic data, however, often taxes the limited processing and storage capabilities of the client communications device. As both those skilled and unskilled recognize, when the processing and/or storage capabilities of the client communications device are overwhelmed, the audio/video presentation may “stumble” and degrade the user experience. Sometimes the client communications device even experiences a fault or failure when the processing and/or storage capabilities are overwhelmed. There is, accordingly, a need in the art for methods and systems of manipulating electronic data that reduce the need for locally-stored computer programs and that reduce the need for local processing requirements.

### BRIEF SUMMARY OF THE INVENTION

The aforementioned problems, and other problems, are reduced by an Analysis Module. This Analysis Module comprises methods, computer systems, computer programs, and computer program products that provide communications services. The Analysis Module values and negotiates communications services over one or multiple networks. A “community” of auction participants develops negotiable currency rules to value optimum segmentation, manipulation, and/or aggregation capabilities of each participating network and/or each participating service provider. A participant may, thereafter, negotiate within the community for these communications services, and the communications services are valued by a history of price, quality, on-time delivery, and/or additional capabilities (e.g., store and transform operations).

This invention discloses methods, systems, and products for providing communications services. One of the embodiments describes a method for providing communications services. This method communicates bids via an online auction to provide the communications services. The communications services are provided, and a rating is received. The rating indicates whether the communications services were satisfactorily provided. The term “communications service” means uploading and/or downloading data and/or voice signals via a communications network.

Another of the embodiments describes another method for providing communications services. Here a bid for the communications services is received during an online auction conducted via a distributed computing network. The communications services are provided according to the terms of the bid. A rating is received, and the rating indicates whether the communications services were satisfactorily provided according to the terms of the bid.

Other embodiments of this invention describe a system for providing communications services. The system includes an Analysis Module stored in a memory device, and a processor communicates with the memory device. The Analysis Module receives a bid for communications services, and the bid is received during an online auction conducted via a distributed computing network. The Analysis Module initiates the communications services, and the Analysis Module receives a rating of the communications services. The rating indicates whether the communications services were satisfactorily provided.

Other embodiments of this invention describe a computer program product. A computer-readable medium stores an Analysis Module. The Analysis Module receives a bid for communications services, and the bid is received during an online auction conducted via a distributed computing network. The Analysis Module initiates the communications services, and the Analysis Module receives a rating of the communications services. The rating indicates whether the communications services were satisfactorily provided.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

These and other features, aspects, and advantages of the embodiments of the present invention are better understood when the following Detailed Description of the Invention is read with reference to the accompanying drawings, wherein:

FIGS. 1 and 2 are schematics illustrating an online auction, according to one of the embodiments of this invention;

FIG. 3 is a schematic illustrating another online auction, according to another of the embodiments of this invention;

FIG. 4 is a flowchart illustrating a method of providing communications services;

FIG. 5 is a flowchart illustrating another method of providing communications services; and

FIGS. 6 and 7 are flowcharts illustrating yet another method of providing communications service.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

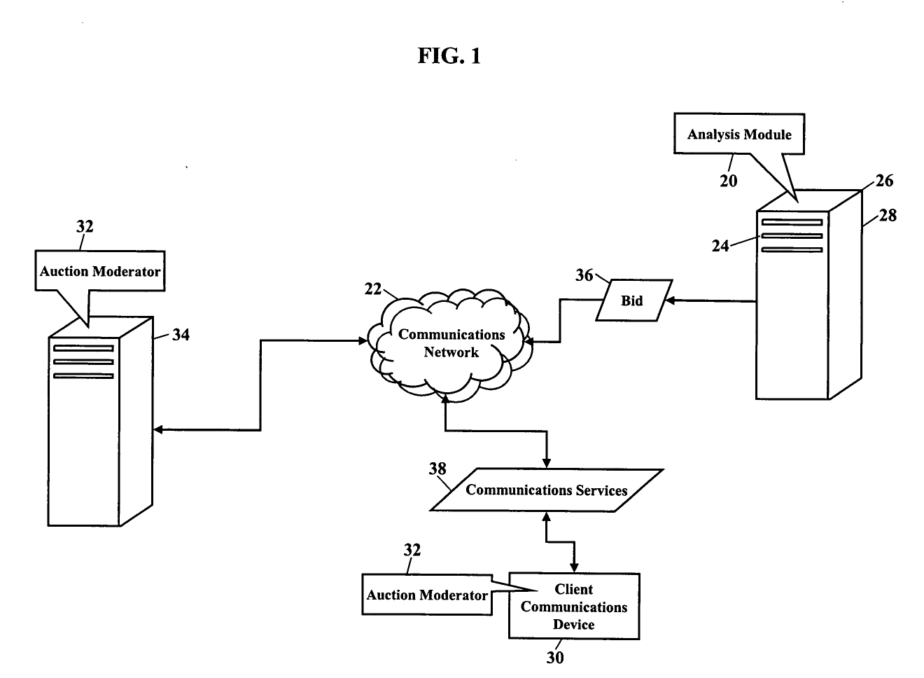

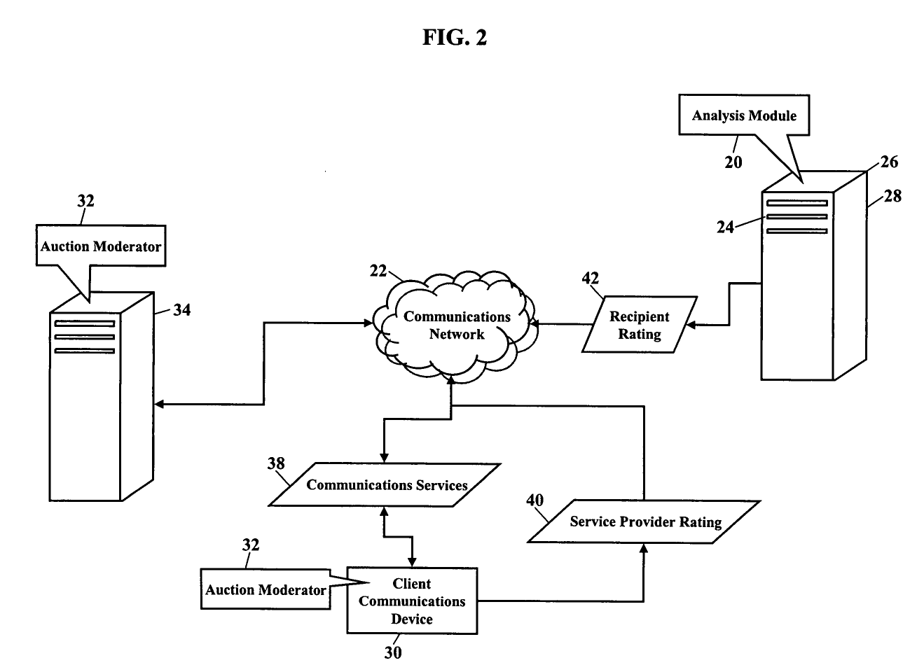

FIGS. 1 and 2 are schematics illustrating an online auction, according to one of the embodiments of this invention. FIG. 1 shows an Analysis Module 20 operating within a communications network 22. This communications network 22 represents just one of the possible operating environments for the Analysis Module 20. The communications network 22 is a generic term describing any of the Public Switched Telephone Network, a data network (e.g., a local area network, a wide area network, and/or a distributed computing network such as the “Internet”), a cellular network (GSM, CDMA, TDMA, and/or an interoperating network), an I.E.E.E. 802 wireless network, an RF wireless network, an ISM wireless network, an IR wireless network, and another wireless network using another portion of the electromagnetic spectrum. The I.E.E.E. 802 wireless network utilizes any of the I.E.E.E 802 family of wireless technology standards. The RF wireless network uses the radio frequency (RF) portion of the electromagnetic spectrum, the ISM wireless network uses the Industrial, Scientific, and Medical (ISM) band of the electromagnetic spectrum, the IR wireless network uses the infrared (IR) portion of the electromagnetic spectrum, and the another wireless network utilizes any other portion/frequency within the electromagnetic spectrum. The Analysis Module 20 is stored within memory 24 of a computer device 26, such as a service provider's computer server 28 communicating with the communications network 22. As this patent will explain, the Analysis Module 20 submits bids to provide communications services to a client communications device 30.

When the client communications device 30 requires communications service, an online auction is conducted. The online auction is conducted by an Auction Moderator 32. The Auction Moderator 32 is a software program that conducts the auction on behalf of the client communications device 30. The Auction Moderator 32 may be stored/maintained within memory of the client communications device 30. The Auction Moderator 32 may alternatively or additionally be stored/maintained within memory of another computer device 34 communicating with, or operating within, the communications network 22. The Auction Moderator 32 presents one or more Graphical User Interfaces (e.g., “GUI's” or webpages) to a community of auction participants. Each auction participant interfaces with the Auction Moderator 32 to buy/sell communications services.

When the client communications device 30 requires communications service, the term “communications service” means the client communications device 30 requests a data upload and/or a data download via a communications network. The term “data” includes electronic information, such as, for example, facsimile, electronic mail (e-mail), text, video, audio, and/or voice in a variety of formats, such as dual tone multi-frequency, digital, analog, and/or others. Additionally, the data may include: (1) executable programs, such as a software application, (2) an address, location, and/or other identifier of the storage location for the data, (3) integrated or otherwise combined files, and/or (4) profiles associated with configuration, authenticity, security, and others. The client communications device 30 may include any computer/communications device utilizing a microprocessor and/or a digital signal processor. The client communications device 30 may include, for example, a computer (laptop, desktop, tablet, server, and other computer systems), a personal digital assistant (PDA), a Global Positioning System (GPS) device, an interactive television, an Internet Protocol (IP) phone, a pager, a plain-old telephone, and/or a cellular/satellite phone.

The auction may be dynamically held or intermittently held. If the auction is dynamically held, the auction is conducted in real-time and each time the client communications device 30 requires communications service. That is, a user of the client communications device 30 may decide to solicit bids each time communications service is required. A dynamically-held auction hopes to obtain the best-available price, performance, speed, and/or other term(s) at any moment. If the auction is intermittently held, the auction is conducted at selected times, dates, usage intervals, and/or other criterion. The user of the client communications device 30, for what ever reason, may decide that a dynamic auction is too cumbersome, perhaps too time consuming, or even undesirable. Whenever the auction is held, the online auction solicits/invites bids to provide the requested communications services.

When the auction is held, bids are received. As FIG. 1 illustrates, the service provider electronically submits a bid 36. The bid 36 is communicated from the service provider's computer device 26 and to the Auction Moderator 32 via the communications network 22. If the Auction Moderator 32 accepts the bid 36, the service provider then provides communications services 38 according to the terms of the bid 36. The communications services 38, for example, may include segmentation, dispersion, and aggregation of data segments. A first data stream is received, and the first data stream includes packets of data packetized according to a packet protocol. The first data stream is segmented into segments, and the segments are dispersed via the communications network 22 for subsequent processing services. Results of the processing services are received and aggregated as a second data stream. The second data stream is then communicated via the communications network 22 to then client communications device 30 or to some other destination, according to the terms of the bid 36.

FIG. 2 is a schematic illustrating a ratings exchange. After the communications services (shown as reference numeral 38 in FIG. 1) are provided, ratings may be exchanged. The ratings provide “feedback” between the service provider and the recipient of the communications services. Positive feedback induces trust within the bidding community, whereas negative feedback forces the service provider and/or the recipient to competitively improve or risk ostracism from the community. FIG. 2, for example, shows the client communications device 30 return communicating a service provider rating 40. The service provider rating 40 is communicated via the communications network 22, and the service provider rating 40 is received by the auction moderator 32. If, however, the Auction Moderator 32 operates from within the client communications device 30, the service provider rating 40 is shared with the Auction Moderator 32. The service provider rating 40 may additionally or alternatively be communicated to the service provider's computer device 26. The service provider rating 40 indicates whether the service provider satisfactorily provided the communications services (shown as reference numeral 38 in FIG. 1). The service provider rating 40 may indicate that the communications services were provided within the terms of the bid 36. The service provider rating 40 may indicate whether the communications services were provided within any cost, quality, and/or timing constraints. The service provider rating 40, for example, may indicate the communications services were provided on-time, within any loss constraints (e.g., maximum amount of lost packets), and within any distortion constraints (e.g., conversion “jitter”). The service provider rating 40 may also indicate whether the communications services were provided according to any processing and/or any display capabilities of the client communications device 30.

FIG. 2 also shows a recipient rating 42. The recipient rating 42 allows the service provider to provide a subjective/objective rating for the recipient of the communications services. Whereas the service provider rating 40 indicates whether the service provider satisfactorily provided the communications services, the recipient rating 42 indicates whether the recipient satisfactorily performed. The recipient rating 42 most commonly will indicate whether the recipient paid for the communications services, according to any terms between the parties. The recipient rating 42, for example, might indicate that the recipient's credit card accepted the charges. The recipient rating 42 might indicate that the recipient timely paid the billed charges within a thirty (30) day grace period (or any other grace period).

Once the ratings are exchanged, the auction moderator 32 may present the ratings. The ratings are presented during a future online auction, and the rating help indicate or “predict” that future communications services will be similarly satisfactorily provided. Positive feedback induces trust within the bidding community, whereas negative feedback risks ostracism from the community. As a member of the community (whether a service provider or a recipient) acquires more and more positive ratings, the member can negotiate within the community for these communications services, and the communications services are valued by a history of quality, on-time delivery, timely payment, and/or additional capabilities (e.g., storing and transforming to the capabilities of the client communications device 30). The ratings may thus act as “currency” within the community. If a service provider has a history of trust, the service provider can command more currency for the provided communications services. If the recipient has a history of trust, the recipient may parlay that trust into cheaper communications services and/or more communications features/services. If, however, a service provider has a history of mistrust, the service provider must accept less currency for communications services. If, likewise, the recipient has a history of mistrust, the recipient may be forced to offer more currency for communications services, and the recipient may not receive some communications features/services. If either the service provider or the recipient has a history of mistrust, either the service provider or the recipient may be ostracized and, thus, dynamically dropped from future auctions, group services, and even the community.

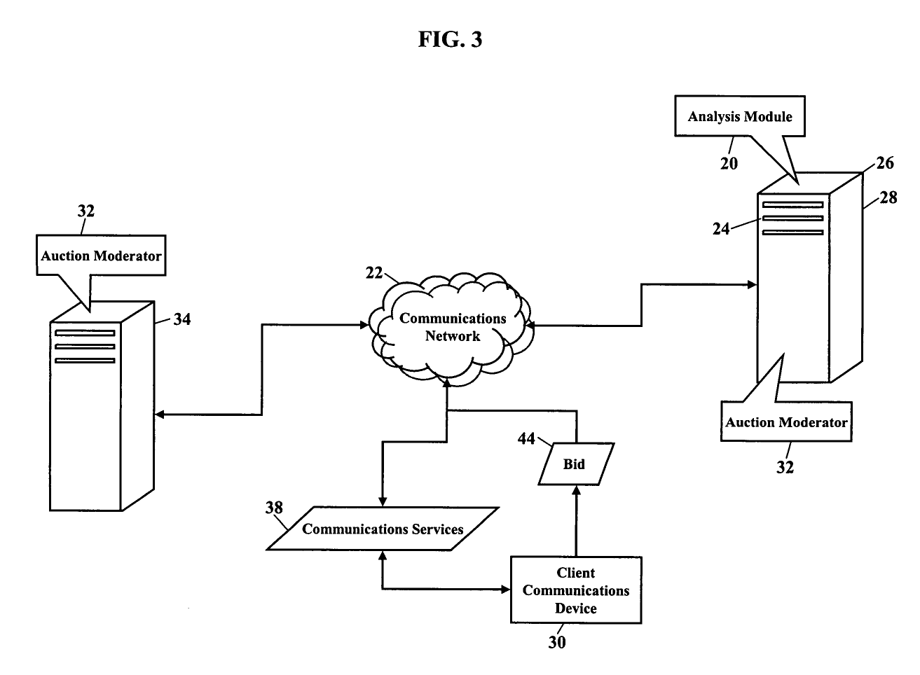

FIG. 3 is a schematic illustrating another online auction, according to another of the embodiments of this invention. Here the service provider solicits bids for communications services, and the Auction Moderator 32 is a software program that conducts the auction on behalf of the service provider. The Auction Moderator 32, then, may operate from within the service provider's computer device 26. An intermediary auctioneer, however, may conduct the auction, so the Auction Moderator 32 may additionally or alternatively operator from within the another computer device 34 communicating with, or operating within, the communications network 22. However the auction is conducted, the bid 44 communicates from the client communications device 30 and to the Auction Moderator 32 via the communications network 22. If the Auction Moderator 32 accepts the bid 44, the service provider then provides the communications services 38 according to the terms of the bid 44.

The service provider auctions communications services. The communications services include downloads and/or uploads of voice and/or data. The service provider, for example, may auction a block of time of usage. The service provider, for example, may auction thirty (30) or sixty (60) minute increments of communications services. The block of time of usage may even be larger (e.g., 5000 minutes) to entice large users of communications services (e.g., individuals, businesses, and governments). The auctioned block of time may include time/day constraints, such that the communications services 38 are only available during specified hours/dates, according to the terms of the auction. The auctioned block of time, however, might also be dynamic or “microscopic,” in that bids are accepted for immediate communications needs. The service provider might have excess capacity at any moment, so the service provider auctions that excess capacity to those recipients having an immediate communications need. The auction block of time might even include bandwidth constraints, such as a maximum data transfer rate and/or a minimum data transfer rate. If the recipient's communications needs fall within the permitted window of data transfer rates, the recipient may dynamically submit bids for each communications need. If, however, the recipient's communications needs at any one moment lie outside the permitted window of data transfer rates, the service provider may choose to dynamically drop the recipient.

The service provider may auction communications services to multiple end users. Perhaps, for example, that multiple end users are participants to a video conference. When the service provider auctions the block of time of usage, the service provider may permit the block of time to be shared between multiple recipients of the video/audio data. The auctioned block of time would allow the recipients to dynamically obtain the best-available performance, quality, and price at the time of the video conference. The service provider could also “reserve” routings and bandwidths to ensure the recipients receive that best-available performance, quality, and price throughout the video conference. The service provider, likewise, could permit the block of time to be shared between multiple telephone numbers, multiple Internet Protocol addresses, and/or multiple client communications devices. The block of time of usage may be shared between multiple client communications devices associated with multiple users. Individuals, business, and/or governments may thus “band together” and purchase a block of time of usage at much higher volumes, and thus perhaps much lower prices, than either could ordinarily obtain.

The service provider may also permit sponsorship. Perhaps, again, that multiple end users are participants to a video conference. Although there are multiple participants, some participants may be unable, or unwilling, to pay for the video conference. Even if all participants are will to pay for the communications service, some participants may not require the quality, speed, or amount of data as other participants. Yet the economics of purchasing “bulk” communications needs are such that some participants may be willing to “sponsor” other participants. The service provider, then, might negotiate with a group of recipients, with some recipients sponsoring other participants. That is, those recipients willing to pay for the communications services “foot the bill” for the recipients unwilling to pay for the communications services. Even though a participant is unwilling to pay for the communications service, that same participant still receives the communications service, albeit at someone else's expense.

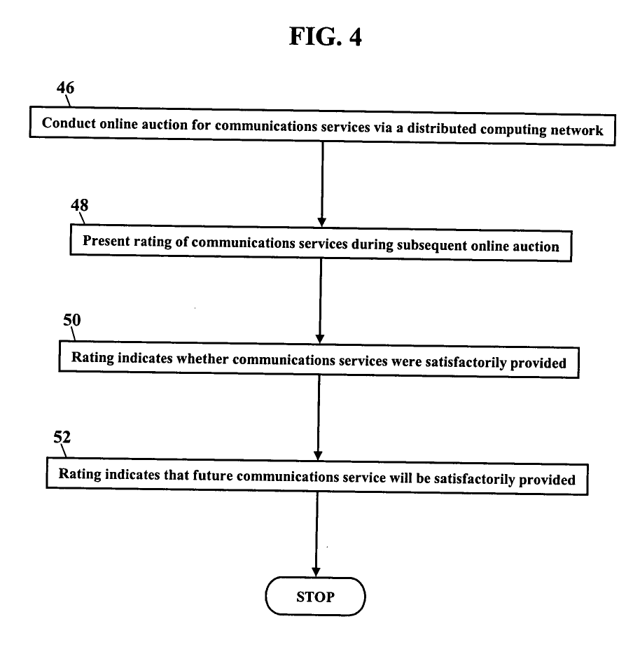

FIG. 4 is a flowchart illustrating a method of providing communications services. An online auction for the communications services is conducted (Block 46). The online auction is conducted via a distributed computing network. A rating of the communications services is presented during a subsequent online auction (Block 48). The rating indicates whether the communications services were satisfactorily provided (Block 50), and the rating indicates that a future communications service will be satisfactorily provided (Block 52).

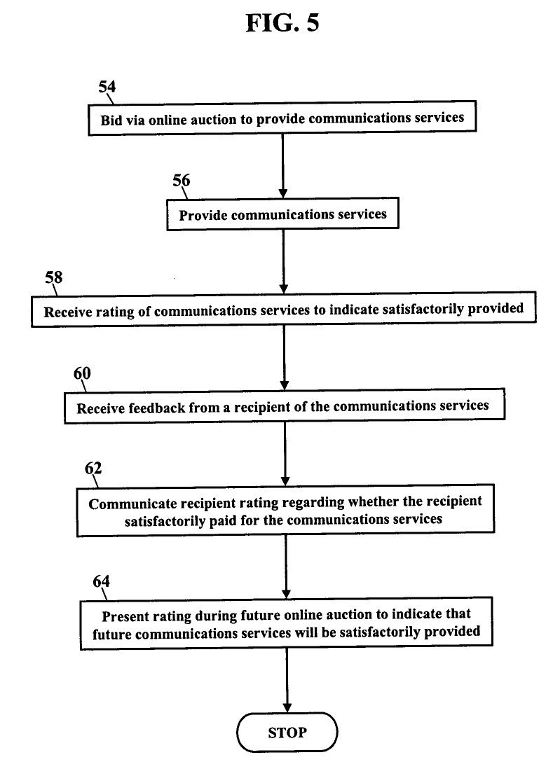

FIG. 5 is a flowchart illustrating another method of providing communications services. This method bids via an online auction to provide the communications services (Block 54). The communications services are provided (Block 56) and a rating of the communications services is received (Block 58). The rating indicates whether the communications services were satisfactorily provided. The rating may include receiving feedback from a recipient of the communications services (Block 60), and the feedback indicates whether the recipient was satisfied with the communications services. The method may further include communicating a recipient rating regarding a recipient of the communications services (Block 62). The recipient rating indicates whether the recipient satisfactorily paid for the communications services. The rating may be presented during a future online auction (Block 64), wherein the rating is used to indicate that future communications services will be satisfactorily provided.

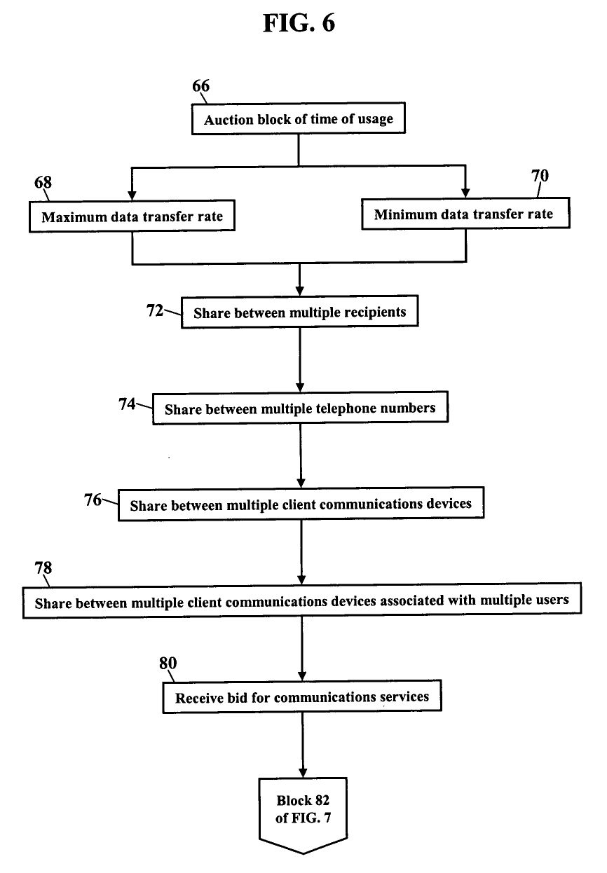

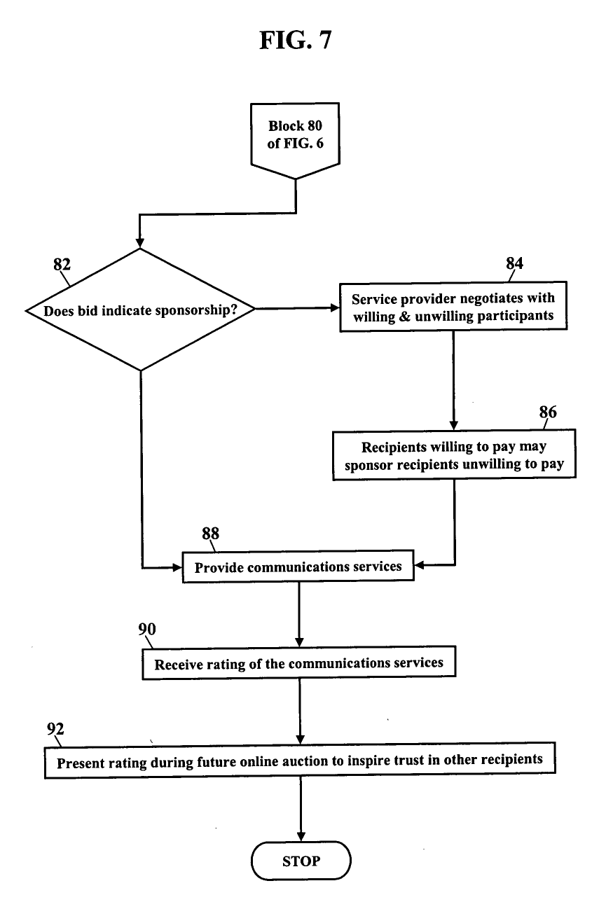

FIGS. 6 and 7 are flowcharts illustrating yet another method of providing communications services. Here a block of time of usage is auctioned (Block 66). The block of time of usage may include a maximum data transfer rate (Block 68) and/or a minimum data transfer rate (Block 70). The block of time may be shared between multiple recipients of the communications services (Block 72), multiple telephone numbers (Block 74), multiple client communications devices (Block 76), and/or multiple client communications devices associated with multiple users (Block 78). A bid for the communications services is received (Block 80).

The flowchart continues with FIG. 7. The bid is received during an online auction conducted via a distributed computing network. If the bid indicates sponsorship (Block 82), then the service provider negotiates with willing and with unwilling participants (Block 84). Those recipients willing to pay for the communications services are permitted to sponsor the recipients unwilling to pay for the communications services (Block 86). The communications services are provided (Block 88) and a rating of the communications services is received (Block 90). The rating indicates whether the communications services were satisfactorily provided. The rating may be presented during a future online auction (Block 92), and the rating is used to inspire trust in other recipients that their future communications services will be satisfactorily provided.

The Analysis Module (shown as reference numeral 20 in FIGS. 1-3) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the Analysis Module to be easily disseminated. A computer program product for providing communications services includes the Analysis Module stored on the computer-readable medium. The Analysis Module receives a bid for the communications services, and the bid is received during an online auction conducted via a distributed computing network. The communications services are provided, and a rating is received via the distributed computing network. The rating indicates whether the communications services were satisfactorily provided.

The Analysis Module may also be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

1. A method of providing communications services, comprising the steps of:
conducting an online auction for the communications services, the online auction conducted via a distributed computing network; and
presenting a rating of the communications services, the rating indicating whether the communications services were satisfactorily provided, the rating presented during a subsequent online auction to indicate that a future communications service will be satisfactorily provided.

2. A method of providing communications services, comprising the steps of:
bidding via an online auction to provide the communications services;
providing the communications services; and
receiving a rating of the communications services, the rating indicating whether the communications services were satisfactorily provided.

3. A method according to claim 2, wherein the step of receiving the rating comprises receiving feedback regarding a recipient of the communications services, the feedback indicating whether the recipient was satisfied with the communications services.

4. A method according to claim 2, wherein the step of receiving the rating comprises receiving the rating from a client communications device associated with a user of the communications services.

5. A method according to claim 2, further comprising communicating a recipient rating regarding a recipient of the communications services, the recipient rating indicating whether the recipient satisfactorily paid for the communications services.

6. A method according to claim 2, further comprising presenting the rating during a future online auction, wherein the rating is used to indicate that future communications services will be satisfactorily provided.

7. A method according to claim 2, wherein the step of providing the communications services comprises:
i) receiving a first data stream comprising packets of data packetized according to a packet protocol,
ii) segmenting the first data stream into segments,
iii) dispersing the segments via a communications network for subsequent processing services,
iv) receiving results of the processing services,
v) aggregating the results of the processing services into a second data stream, and
vi) communicating the second data stream via the communications network.

8. A method of providing communications services, comprising the steps of:
receiving a bid for the communications services, the bid received during an online auction conducted via a distributed computing network;
providing the communications services; and
receiving a rating of the communications services via the distributed computing network, the rating indicating whether the communications services were satisfactorily provided.

9. A method according to claim 8, further comprising auctioning a block of time of usage.

10. A method according to claim 9, wherein the block of time comprises at least one of i) a maximum data transfer rate and ii) a minimum data transfer rate.

11. A method according to claim 8, further comprising auctioning a block of time of usage, wherein the block of time may be shared between multiple recipients of the communications services.

12. A method according to claim 8, further comprising auctioning a block of time of usage, wherein the block of time may be shared between multiple telephone numbers.

13. A method according to claim 8, further comprising auctioning a block of time of usage, wherein the block of time may be shared between multiple client communications devices.

14. A method according to claim 8, further comprising auctioning a block of time of usage, wherein the block of time may be shared between multiple client communications devices associated with multiple users.

15. A method according to claim 8, further comprising negotiating with a group of recipients for the communications services, the group comprising recipients willing to pay for the communications services and recipients unwilling to pay for the communications services, wherein the recipients willing to pay for the communications services are permitted to sponsor the recipients unwilling to pay for the communications services.

16. A method according to claim 15, wherein the step of providing the communications services comprises providing the communications services to both recipients willing to pay for the communications services and recipients unwilling to pay for the communications services.

17. A method according to claim 8, wherein the step of receiving the rating comprises receiving the rating from a recipient of the communications services, the rating indicating whether the recipient was satisfied with the communications services.

18. A method according to claim 8, further comprising presenting the rating during a future online auction, wherein the rating is used to inspire trust in other recipients that their future communications services will be satisfactorily provided.

19. A method according to claim 8, wherein the step of providing the communications services comprises:
i) receiving a first data stream comprising packets of data packetized according to a packet protocol,
ii) segmenting the first data stream into segments,
iii) dispersing the segments via a communications network for subsequent processing services,
iv) receiving results of the processing services,
v) aggregating the results of the processing services into a second data stream, and
vi) communicating the second data stream via the communications network.

20. A computer program product, comprising:
a computer-readable medium; and
an Analysis Module stored on the computer-readable medium, the Analysis Module receiving a bid for communications services, the bid received during an online auction conducted via a distributed computing network, the Analysis Module initiating the communications services, and the Analysis Module receiving a rating of the communications services, the rating indicating whether the communications services were satisfactorily provided.
